(19) United States
(12) Patent Application Publication
(10) Pub. No.: US 2011/0097621 A1
(43) Pub. Date: Apr. 28, 2011

(54) PROTECTIVE COVER ASSEMBLY FOR BATTERY CONTACTS

(75) Inventor: JIN-MIN HE, Shenzhen City (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/791,049

(22) Filed: Jun. 1, 2010

(30) Foreign Application Priority Data
Oct. 26, 2009 (CN) 200910308838.6

(51) Int. Cl. H01M 2/00

(52) U.S. Cl. 429/163

(57) ABSTRACT

A protective cover assembly is used for a battery. The battery includes a plurality of contacts. The protective cover assembly includes a door frame and a slidable door. The door frame is formed on the battery adjacent to the contacts. The slidable door is slidably received in the door frame. The slidable door can be slid along the door frame. The contacts are covered or exposed by the slidable door depending upon the position of the slidable door.

### BACKGROUND

1. Technical Field

The present disclosure generally relates to protective cover assemblies and, particularly, to a protective cover assembly for battery contacts.

2. Description of Related Art

Batteries are widely used in portable electronic devices, such as personal digital assistants (PDAs), mobile phones, and so on. Conventional batteries typically have exposed contacts for electrically connecting to circuits.

However, exposed contacts are easily scraped during replacement process of the battery. Thus, performance and life of the battery can be greatly reduced.

Therefore, there is room for improvement within the art.

### BRIEF DESCRIPTION OF THE DRAWINGS

Many aspects of the protective cover assembly can be better understood with reference to the following drawings. The components in the drawings are not necessarily drawn to scale, the emphasis instead being placed upon clearly illustrating the principles of the protective cover assembly. Moreover, in the drawings, like reference numerals designate corresponding parts throughout the several views, in which:

FIG. 1 is an exploded, isometric view of a battery employing a protective cover assembly;

FIG. 2 is an assembled view of FIG. 1 showing the slidable door in a closed state;

FIG. 3 is similar to FIG. 2, but showing the slidable door in an open state; and

FIG. 4 is a cross-sectional view of the battery of FIG. 3.

### DETAILED DESCRIPTION

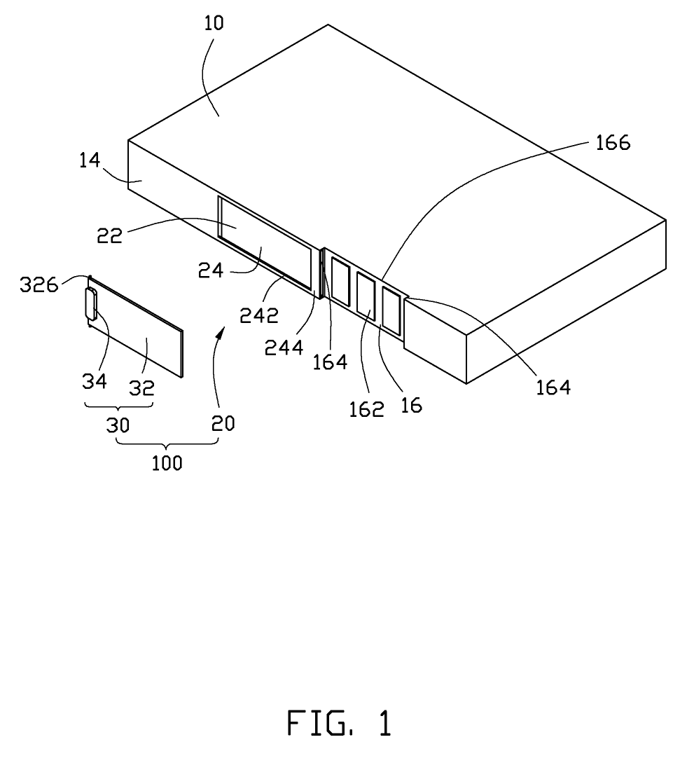

FIG. 1 shows a protective cover assembly 100 used for protecting contacts of a battery 10. The battery 10 includes a side surface 14. One portion of the side surface 14 is recessed to define a contact area 16. A plurality of contacts 162 are disposed on the contact area 16. The protective cover assembly 100 includes a door frame 20 and a slidable door 30. The slidable door 30 is slidably received in the door frame 20 to selectively expose or cover the contacts 162.

The door frame 20 is formed on the side surface 14 adjacent to the contact area 16. The door frame 20 defines an opening 22 and a slot 24. The slidable door 30 may be retained in the slot 24 and be exposed from the opening 22. The opening 22 communicates with the slot 24, but is slightly smaller than the slot 24 so that edge portions 242 and side portions 244 of the door frame 20 bounding the opening 22 act to retain the sliding door 30 to the battery 14. One of the side portions 244 is formed at the boundary where the door frame 20 meets the contact area 16, and includes a sidewall 164. The slot 24 communicates with the sidewall 164.

The slidable door 30 includes a plate portion 32 and a handle 34. The size of the plate portion 32 is equal to that of the opening 18 to allow the plate portion 32 to pass through the opening 18. A post 326 protrudes from each of two opposite sides of the plate portion 32. The plate portion 32 and the posts 326 are slidably received in the slot 24. Two posts 326 are limited by the edge portions 242 to prevent the slidable door 30 from separating from the slot 24. The handle 34 is formed at one end of the plate portion 32 for resisting the side portion 244 to prevent the handle 34 from sliding out from the slot 24. The opening 22 may accommodate sliding of a handle 34

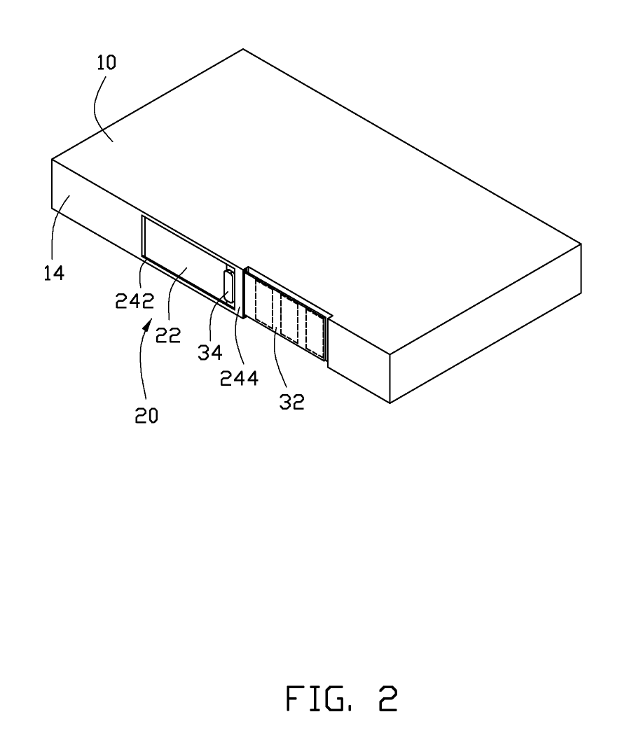

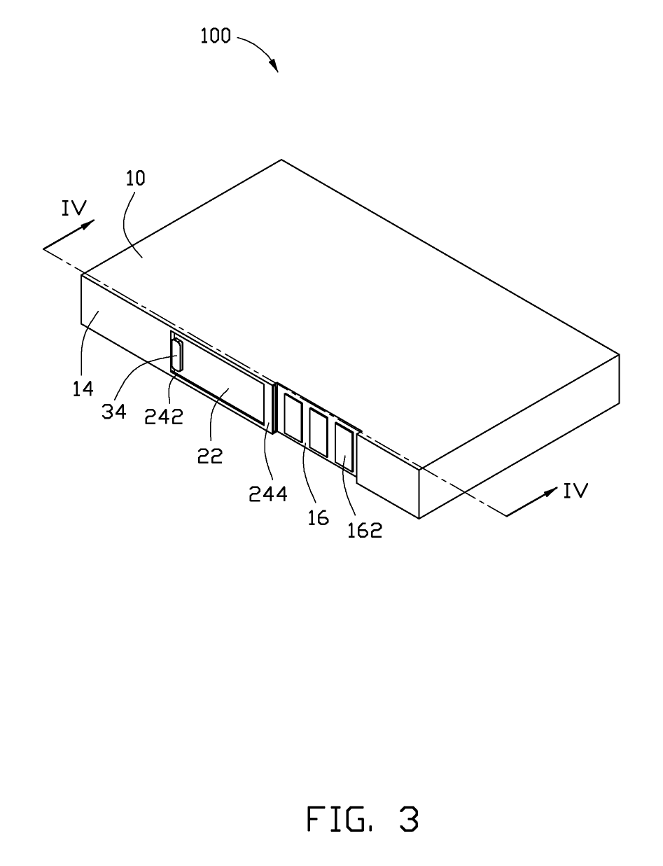

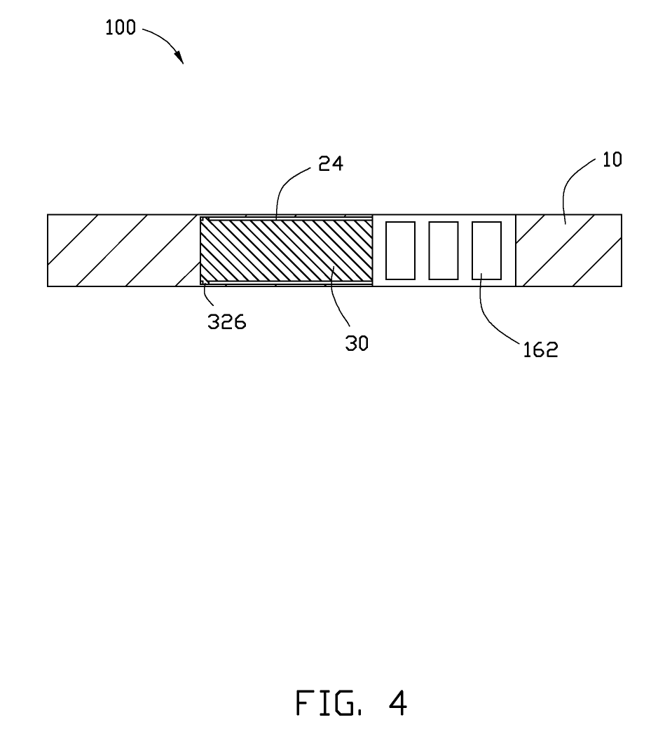

During assembly of the protective cover assembly 100, referring to FIGS. 2 to 4, the plate portion 32 passes through the opening 20. The posts 326 are pressed inward, and forced into the slot 24. Accordingly, the plate portion 32 and the posts 326 are slidably received in the slot 24. Thus, the protective cover assembly 100 is assembled to the battery 10. To close the slidable door 30, the handle 34 is used to slide the plate portion 32 in the slot 24. The plate portion 32 further slides out from the sidewall 164 to cover the contacts 162 until the handle 34 resists the side portion 244. Thus, the contacts 162 are completely protected under the slidable door 30.

To open the slidable door 30, the handle 34 is slid toward the opening 22. The plate portion 32 further slides in from the sidewall 164 to allow the contacts 162 to be exposed.

As described above, the exemplary embodiment provides a protective cover assembly for portable electronic devices, such as mobile phones. The protective cover assembly can be easily opened and more user-friendly.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A protective cover assembly for a battery, the battery including a plurality of contacts, the protective cover assembly comprising:
a door frame formed on the battery adjacent to the contacts;
a slidable door slidably received in the door frame and for covering the contacts when the slidable door is in a closed position;
wherein the slidable door is slid along the door frame in an opening direction, the contacts are exposed.

2. The protective cover assembly as claimed in claim 1, wherein the slidable door includes a plate portion, and a post protrudes from each of two opposite sides of the plate portion, the door frame defines a slot, the posts and the slidable door are slidably received in the slot.

3. The protective cover assembly as claimed in claim 2, wherein a handle is formed at one end of the plate portion.

4. The protective cover assembly as claimed in claim 1, wherein the door frame defines an opening and a slot, the slot communicates with the opening, edge portions and side portions of the door frame bound the opening, and the slidable door is slidably received in the slot, and exposed from the opening.

5. The protective cover assembly as claimed in claim 4, wherein the slidable door includes a plate portion and two posts protruding from two opposite sides of the plate portion, the edge portions prevent the posts from separating from the slot.

6. The protective cover assembly as claimed in claim 4, wherein the opening is shorter than the slot, one of the side portions is formed at the boundary where the door frame meets the contacts, an handle is formed at one end of the plate portion for resisting the side portion.

7. A combination comprising:
a battery including a side surface defining a groove, a plurality of contact formed in the groove;
a door frame formed on the battery adjacent to the groove, the door frame defines a slot;
a slidable door slidably received in the slot to cover or expose the contacts depending upon the position of the slidable door.

8. The combination as claimed in claim 7, wherein the slidable door includes a plate portion, and a post protrudes from each of two opposite sides of the plate portion, the posts and the slidable door are slidably received in the slot.

9. The combination as claimed in claim 8, wherein the door frame defines an opening and a slot, the slot communicates with the opening, edge portions and side portions of the door frame bound the opening, and the slidable door is slidably received in the slot, and is exposed from the opening.

10. The combination as claimed in claim 9, wherein the slidable door includes a plate portion and two posts protruding from two opposite sides of the plate portion, the edge portions prevent the posts from separating from the slot.

11. The combination as claimed in claim 9, wherein the opening is shorter than the slot, one of the side portions is formed at the boundary where the door frame meets the contacts, an handle is formed at one end of the plate portion for resisting the side portion.
